(19) United States
(12) Patent Application Publication
(10) Pub. No.: US 2025/0269525 A1
(43) Pub. Date: Aug. 28, 2025

(54) ROBOT SYSTEM

(71) Applicant: KAWASAKI JUKOGYO KABUSHIKI KAISHA, Kobe-shi (JP)

(72) Inventors: Yoshitaka MURAMATSU, Kobe-shi (JP); Shogo FUJITA, Kobe-shi (JP); Takuya ICHISE, Kobe-shi (JP)

(73) Assignee: KAWASAKI JUKOGYO KABUSHIKI KAISHA, Kobe-shi (JP)

(21) Appl. No.: 19/064,268

(22) Filed: Feb. 26, 2025

(30) Foreign Application Priority Data
Feb. 28, 2024 (JP) 2024-028962

(51) Int. Cl. B25J 9/16; B25J 9/00; B25J 19/02

(52) U.S. Cl. CPC B25J 9/1661; B25J 9/0093; B25J 9/1653; B25J 19/023

(57) ABSTRACT

A robot system includes: a robot that is configured to perform work on a workpiece transported to a work area; a sensor that is configured to output a signal related to inclination of the workpiece with respect to a reference orientation when the robot performs work on the workpiece, the signal being related to the inclination of the workpiece that arrived at the work area; and a transport vehicle that is configured to transport the workpiece to the work area and configured to correct the inclination of the workpiece based on the signal from the sensor so that the workpiece is aligned with the reference orientation in the work area.

### CROSS-REFERENCE TO RELATED APPLICATIONS

This application is based on and claims priority under 35 USC § 119 from Japanese Patent Application No. 2024-028962 filed on Feb. 28, 2024, the contents of which are incorporated herein by reference.

### TECHNICAL FIELD

The technology disclosed herein relates to a robot system.

### BACKGROUND

Patent Literature 1 describes a robot system of the related art. The robot system of the related art is used in an assembly line for an automobile body. On the assembly line, side members are attached to an underbody. The robot system of the related art includes a first multi-axis robot and a second multi-axis robot. The first multi-axis robot positions the underbody. The second multi-axis robot welds the underbody and the side members. The robot system of the related art further includes an automatic guided vehicle (AGV) that transports the underbody to an assembly area. The AGV travels along a magnetic tape on a floor surface.

Patent Literature 1: Japanese Patent No. 6887738

In a work area where a robot performs work on a workpiece, a reference orientation of the workpiece is determined. The reference orientation of a workpiece is an orientation of the workpiece when the robot performs work on the workpiece, and is an orientation within a horizontal plane. The reference orientation of a workpiece is usually an orientation along a transport direction when the workpiece is transported to the work area.

A robot system used in an automobile manufacturing line is required to adjust an orientation of a workpiece with high accuracy. The reason is that regarding a long workpiece such as an automobile body, even a slight deviation in orientation can result in a large deviation in position at an end of the workpiece.

In the robot system of the related art, a workpiece that arrived at the work area may be inclined with respect to the reference orientation. It is because the AGV transports the workpiece to the work area. A pair of guide rollers and a positioning device are placed in the work area of the robot system of the related art. The pair of guide rollers position the AGV in a vehicle width direction, and the positioning device positions the AGV in the front-rear direction. Combination of the pair of guide rollers and the positioning device cannot accurately align the orientation of the workpiece with the reference orientation.

### SUMMARY

A robot system includes: a robot that is configured to perform work on a workpiece transported to a work area; a sensor that is configured to output a signal related to inclination of the workpiece with respect to a reference orientation when the robot performs work on the workpiece, the signal being related to the inclination of the workpiece that arrived at the work area; and a transport vehicle that is configured to transport the workpiece to the work area and configured to correct the inclination of the workpiece based on the signal from the sensor so that the workpiece is aligned with the reference orientation in the work area.

### BRIEF DESCRIPTION OF DRAWINGS

FIG. 1 illustrates a robot system applied to a manufacturing line of an automobile.

FIG. 2 illustrates a robot system.

FIG. 3 is a block diagram of the robot system.

FIG. 4 is a block diagram of an autonomous mobile robot (AMR).

FIG. 5 illustrates a procedure for correcting inclination of a workpiece by an AMR including a rotary table.

FIG. 6 is a flowchart illustrating a control procedure of the AMR.

FIG. 7 illustrates a modification example of the AMR.

FIG. 8 illustrates a procedure for correcting inclination of a workpiece using an AMR that can rotate instantly.

FIG. 9 illustrates another modification example of the AMR.

FIG. 10 illustrates still another modification example of the AMR.

FIG. 11 illustrates a stopper placed in a path of the AMR.

FIG. 12 illustrates a procedure for correcting inclination of a workpiece by an AMR using a stopper.

FIG. 13 illustrates a procedure for correcting inclination of a workpiece by the AMR using the stopper.

FIG. 14 illustrates a modification example of a sensor.

### DESCRIPTION OF EMBODIMENTS

Hereinafter, embodiments of a robot system will be described with reference to the drawings. The robot system described herein is exemplary.

### Overall Structure of Robot System

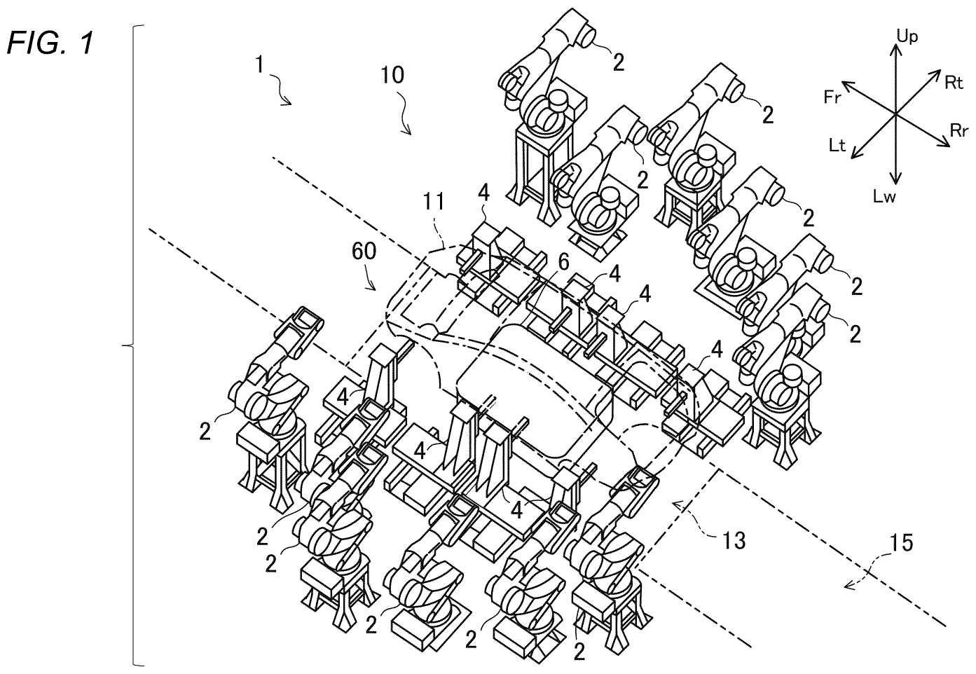

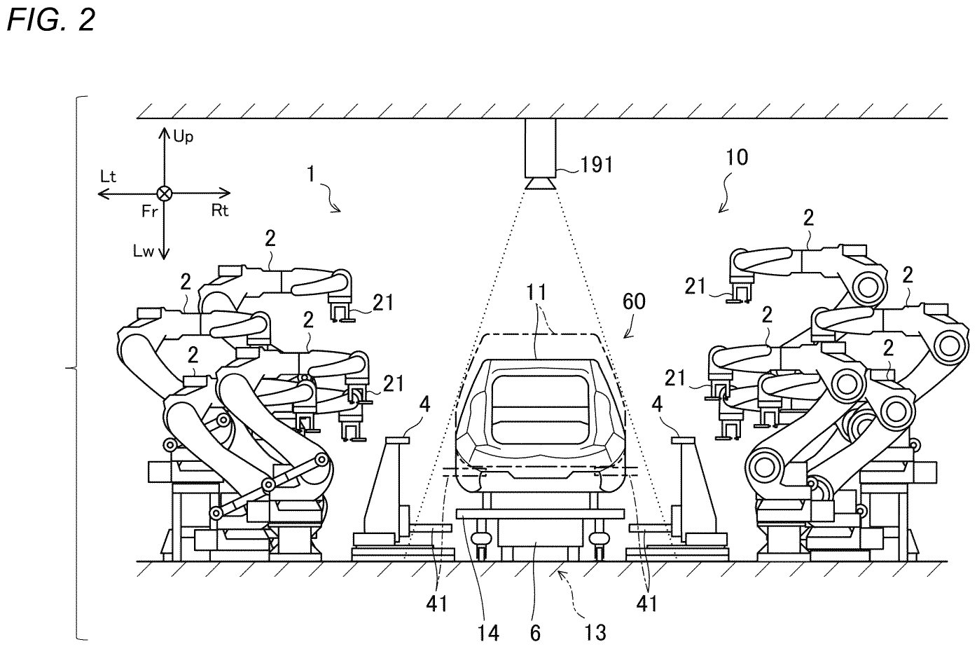

FIG. 1 is a perspective view of a robot system 1 as viewed obliquely from above. FIG. 2 is a rear view of the robot system 1 as seen from the rear. The robot system 1 is applied to a manufacturing line 10 in an automobile factory. In the illustrated manufacturing line 10, welding, more specifically, spot welding is performed on a body 11 of an automobile.

Front Fr, rear Rr, right Rt, left Lt, top Up, and bottom Lw of the robot system 1 are defined as follows with reference to the body 11 on which the robot system 1 is to work.

The front Fr of the robot system 1 is a left inner side in a direction connecting a right front side and the left inner side of the paper in FIG. 1. The front Fr of the robot system 1 corresponds to front of the body 11 of the automobile, and the rear Rr of the robot system 1 corresponds to rear of the body 11 of the automobile. As described below, a front-rear direction corresponds to a transport direction of the body 11.

The right Rt of the robot system 1 is a right inner side in a direction connecting a left front side and the right inner side of the paper in FIG. 1. The right Rt of the robot system 1 corresponds to right of the body 11 of the automobile. The left Lt of the robot system 1 corresponds to left of the body 11 of the automobile. A left-right direction is a direction horizontally perpendicular to the front-rear direction.

The top Up of the robot system 1 is an upper side of the paper in FIG. 1, and the bottom Lw of the robot system 1 is a lower side of the paper. Top and bottom of the robot system 1 correspond to top and bottom of the body 11 of the automobile. A top-bottom direction is a direction vertically perpendicular to the front-rear direction.

The above definitions are used to explain the robot system 1, and are not used to limit a structure or a configuration of the robot system 1 and elements included in the robot system 1 disclosed herein.

The robot system 1 includes a robot 2. The robot 2 performs work on a workpiece transported to a work area 13. The work area 13 is located on a path 15 of an AMR 6 described below, and refers to an area where the workpiece transported by the AMR 6 stays to be worked on by the robot 2. The workpiece of the robot 2 is the body 11. The work performed by the robot 2 on the body 11 is welding.

The robot 2 is a vertical articulated robot having five to seven axes. As illustrated in FIG. 2, the robot 2 includes a welding gun 21 as an end effector. The robot 2 is not limited to a vertical articulated robot.

The robot system 1 includes a plurality of robots 2. The robot system 1 in the drawing includes twelve robots 2. The twelve robots 2 are located on left and right sides so that the body 11 is interposed therebetween. On the right side of the body 11, six robots 2 are arranged in the front-rear direction of the body 11. Similarly, on the left side of the body 11, six robots 2 are arranged in the front-rear direction of the body 11. Each robot 2 performs welding at different locations on the body 11. The number of robots 2 in the robot system 1 is not limited to a specific number. An arrangement of the robots 2 in the robot system 1 is also not limited to a specific arrangement.

The robot system 1 includes a locator 4. The locator 4 is not an essential element of the robot system 1. As indicated by a dashed line in FIG. 2, the locator 4 lifts and supports the body 11 while the robot 2 is working. The locator 4 in the illustrated example is a three-axis orthogonal robot. The locator 4 is provided with a rod 41 that engages with the body 11. The rod 41 extends in the left-right direction. A tip of the rod 41 engages with the body 11. The locator 4 changes a position of the tip of the rod 41 back and forth, left and right, and up and down.

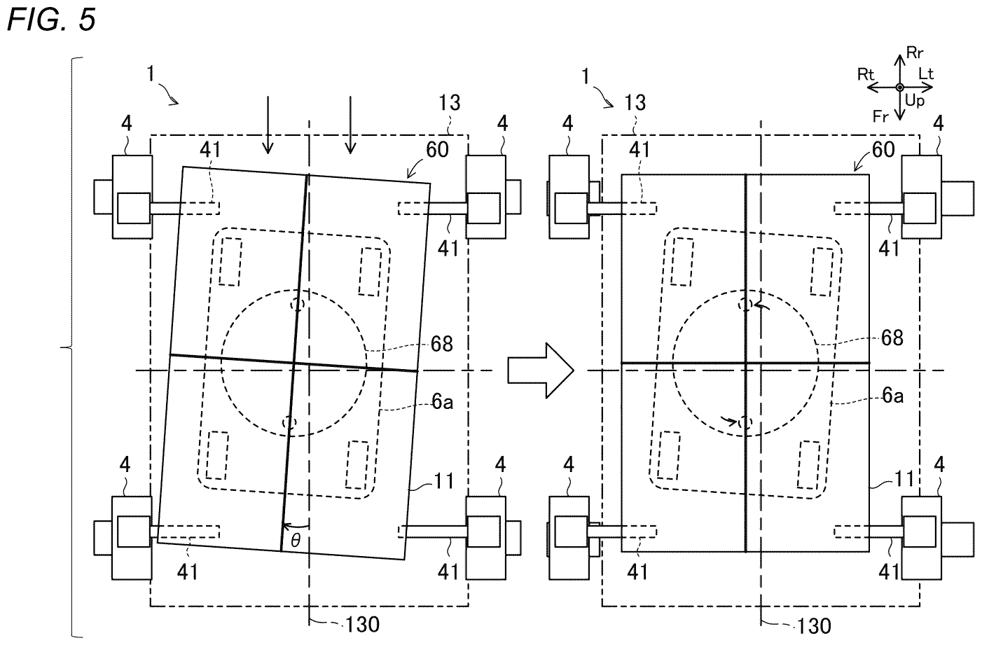

The robot system 1 includes a plurality of locators 4. The robot system 1 in the drawing includes eight locators 4. The eight locators 4 are located on left and right sides so that the body 11 is interposed therebetween. On the right side of the body 11, four locators 4 are arranged in the front-rear direction of the body 11. As illustrated in FIG. 5, one of the four locators 4 supports a right front end of the body 11, and another one of the four locators 4 supports a right rear end portion of the body 11. The remaining two locators 4 not illustrated in FIG. 5 support a center portion of the right side of the body 11 as illustrated in FIG. 1. Similarly, on the left side of the body 11, four locators 4 are arranged in the front-rear direction of the body 11. As illustrated in FIG. 5, one of the four locators 4 supports a left front end of the body 11, and another one of the four locators 4 supports a left rear end portion of the body 11. The remaining two locators 4 not illustrated in FIG. 5 support a center portion of the left side of the body 11 as illustrated in FIG. 1.

The robot system 1 includes one or a plurality of transport vehicles. The transport vehicle transports a workpiece to the work area 13. The transport vehicle is an autonomous mobile robot (AMR) 6. The AMR 6 travels on a flat floor surface of a factory. As illustrated in FIG. 2, the body 11 is placed on a carriage 14. The AMR 6 is located below the carriage 14 and engages with the carriage 14. The AMR 6 transports the body 11 via the carriage 14. The AMR 6 may directly support the body 11 without using the carriage 14. An appearance of the AMR 6 illustrated in FIG. 1 or 2 is an example. A structure of the AMR 6 will be described below.

A moving body 60 is configured to include at least the AMR 6 and the body 11 and to move to the work area 13 of the manufacturing line 10.

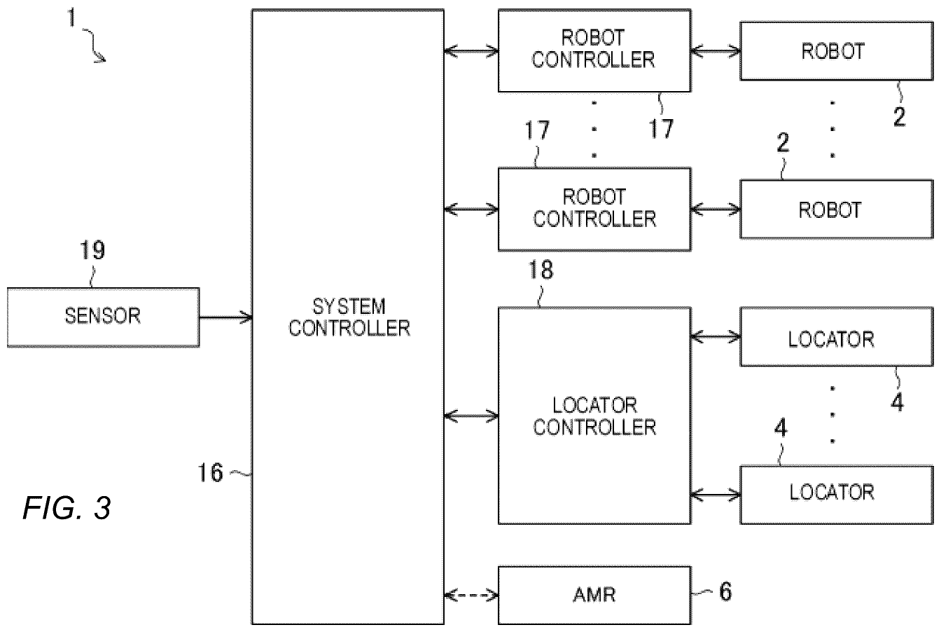

FIG. 3 is a block diagram of the robot system 1. The robot system 1 includes a system controller 16. The system controller 16 is not an essential element of the robot system 1. The system controller 16 controls all of the robot system 1.

The robot system 1 includes a robot controller 17. The robot controller 17 is not an essential element of the robot system 1. The robot controller 17 is electrically connected to the system controller 16. The electrical connection includes a wired or wireless connection. The robot controller 17 is also electrically connected to the robot 2. The robot controller 17 and the robot 2 are connected in a one-to-one relationship. The number of robot controllers 17 in the robot system 1 is the same as the number of robots 2.

The robot controller 17 controls the robot 2. More specifically, the robot controller 17 receives a control signal from the system controller 16 and outputs a control signal to the robot 2. The robot 2 receives a control signal from the robot controller 17, and here, performs welding work on the body 11.

The robot system 1 includes a locator controller 18. The locator controller 18 is not an essential element of the robot system 1. The locator controller 18 is electrically connected to the system controller 16. The electrical connection includes a wired or wireless connection. The locator controller 18 is also electrically connected to the plurality of locators 4. The robot system 1 may include a plurality of locator controllers 18.

The locator controller 18 controls the locator 4. More specifically, the locator controller 18 receives a control signal from the system controller 16 and outputs the control signal to the locator 4. The locator 4 receives the control signal from the locator controller 18 and positions and supports the body 11 delivered from the AMR 6 at a predetermined position.

The robot system 1 includes a sensor 19. The sensor 19 is electrically connected to the system controller 16. The sensor 19 outputs a signal related to inclination of the body 11 that arrived at the work area 13 to the system controller 16 as described specifically below. The sensor 19 includes an external camera 191. The external camera 191 is located above the work area 13 as illustrated in FIG. 2. The external camera 191 photographs the body 11 located in the work area 13 from above. An image captured by the external camera 191 is transmitted to the system controller 16. The system controller 16 determines a degree of inclination of the body 11 in a horizontal plane based on the image captured by the external camera 191.

### Structure of AMR

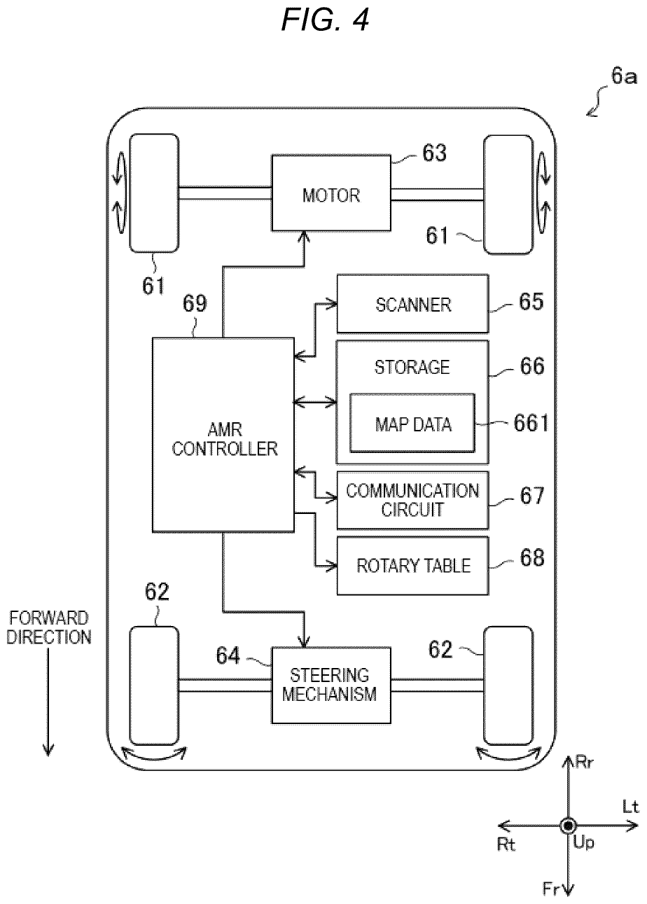

FIG. 4 illustrates a structure of the AMR 6. An AMR 6a in FIG. 4 is an example of the AMR 6.

The AMR 6a includes a plurality of wheels that roll on a floor surface. The wheels include two drive wheels 61 and two steering wheels 62. The two drive wheels 61 are located on the same rotation shaft extending in the left-right direction. The drive wheels 61 are, for example, rear wheels. The drive wheels 61 may be front wheels. The drive wheel 61 is mechanically connected to a motor 63. The motor 63 is driven by power supplied from a battery. The battery is mounted on the AMR 6a. The motor 63 is a drive source for driving the AMR 6a. A driving force of the motor 63 is transmitted to the drive wheel 61 and rotates the drive wheel 61. Rotation of the drive wheels 61 causes the AMR 6a to move (see arrow in FIG. 4).

The steering wheels 62 are, for example, passive wheels. The steering wheels 62 are located on a side opposite to the drive wheels 61 in the front-rear direction of the AMR 6a. The two steering wheels 62 are located on the same rotation shaft extending in the left-right direction. The steering wheel 62 is mechanically connected to a steering mechanism 64. The steering mechanism 64 changes an orientation of the steering wheels 62 as illustrated by arrows in FIG. 4. Changing the orientation of the steering wheels 62 changes a traveling direction of the AMR 6a. The number of steering wheels 62 may be one.

The AMR 6a includes a scanner 65. The scanner 65 obtains information on surroundings of the AMR 6a. The scanner 65 includes, for example, a light detection and ranging (LiDAR). The scanner 65 is not limited to LiDAR.

The AMR 6a includes a storage 66. The storage 66 stores various types of data. The data stored in the storage 66 includes map data 661. The map data 661 is map data of inside of a factory including the manufacturing line 10. Before transporting the body 11, the AMR 6a autonomously travels within the factory and creates the map data 661 using the scanner 65 while traveling. The AMR 6a may obtain the map data 661 created in advance from an external source.

The AMR 6a includes a communication circuit 67. The communication circuit 67 performs wireless communication with the system controller 16. The communication circuit 67 transmits, for example, position information of the AMR 6a to the system controller 16. The communication circuit 67 receives information on, for example, inclination of the body 11 from the system controller 16.

The AMR 6a includes a rotary table 68. The rotary table 68 is located on a top surface of the AMR 6a. FIG. 5 is a top view of the AMR 6a transporting the body 11. FIG. 5 illustrates a schematic diagram of the body 11 and the AMR 6a. The carriage 14 is not drawn in FIG. 5. The rotary table 68 rotates in both a clockwise direction and a counterclockwise direction about a vertical axis on the top surface of the AMR 6a. The rotary table 68 rotates relative to a main body of the AMR 6a. The rotary table 68 includes a drive source. The drive source is, for example, an electric motor. The electric motor may include a servo motor or a stepping motor. More specifically, the rotary table 68 includes a rotary motor that rotates the rotary table 68 about the vertical axis, and a lifting motor that lifts and lowers the rotary table 68. As will be described below, the rotary table 68 rotates when the AMR 6a is stopped. When the rotary table 68 rotates, the body 11 rotates about the vertical axis via the carriage 14. The body 11 rotates instantly without moving in the front-rear direction or the left-right direction.

The AMR 6a includes an AMR controller 69. The AMR controller 69 controls the AMR 6a. The AMR controller 69 is electrically connected to the motor 63, the steering mechanism 64, the scanner 65, the storage 66, the communication circuit 67, and the rotary table 68.

When creating the map data 661, the AMR controller 69 outputs control signals to the motor 63 and the steering mechanism 64 to drive the AMR 6a and creates the map data 661 based on a signal from the scanner 65. The AMR controller 69 stores the created map data 661 in the storage 66.

The AMR controller 69 receives a control signal from the system controller 16 via the communication circuit 67, and causes the AMR 6a to execute an operation according to the received control signal. The AMR 6a travels to a position designated by the system controller 16, that is, to the work area 13 of the robot 2. When the AMR 6a travels, the AMR controller 69 sets a path 15 for the AMR 6a based on the map data 661. While the AMR 6a is traveling, the AMR controller 69 determines a self-position of the AMR 6a based on the signal from the scanner 65 and the map data 661. The AMR 6a autonomously travels to the designated position along the path 15, whereby the body 11 is transported to the work area 13.

### Control of AMR

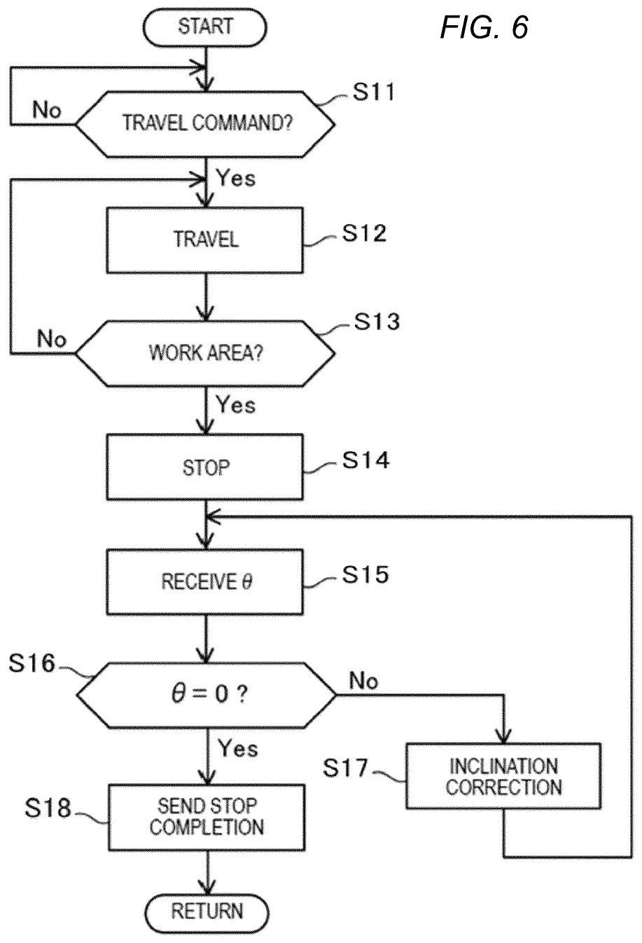

Next, characteristic control of the AMR 6a will be described with reference to FIGS. 5 and 6. Characteristic control relates to inclination correction of the workpiece by the AMR 6a. When the AMR 6a arrives at the designated work area 13, orientation of the AMR 6a may be tilted from a predetermined orientation. The reason is that the AMR 6a does not require a guide such as a rail that mechanically engages with the AMR 6a to regulate the orientation of the AMR 6a. When the orientation of the AMR 6a is tilted, orientation of the body 11 being transported by the AMR 6a is also tilted from the reference orientation.

The AMR 6a can travel while correcting the orientation of the AMR 6a based on scan data from the scanner 65. However, when the AMR 6a corrects the orientation with high accuracy during travel, a long time is required for correction because small corrections of the orientation of the AMR 6a is repeated. When a long time is required for correction of the orientation, a long time is required to transport the body 11 to the work area 13, so that production efficiency of the manufacturing line 10 decreases.

The reference orientation of the body 11 is an orientation within a horizontal plane, and is the orientation of the body 11 when the robot 2 performs welding on the body 11. The reference orientation of the body 11 is an orientation along the transport direction when the body 11 is transported to the work area 13. Therefore, the predetermined orientation of the AMR 6a is an orientation along an ideal forward direction of the AMR 6a that arrived at the work area 13.

FIG. 5 illustrates a procedure for correcting the inclination of the body 11 by the AMR 6a. FIG. 5 illustrates the work area 13 where the AMR 6a stops, the locators 4 placed in the work area 13, the AMR 6a located in the work area 13, and the body 11 transported to the work area 13 by the AMR 6a. For easy understanding, the locators 4 illustrated in FIG. 5 are four locators 4 supporting four corners of the body 11. The work area 13 in FIG. 5 is drawn to be sufficiently large compared to a size of the body 11. In FIG. 5, a forward direction of the AMR 6a is from top to bottom of the paper. The top-bottom direction of the paper in FIG. 5 is an ideal orientation of the AMR 6a that arrived at the work area 13. The reference orientation of the body 11 is indicated by a dashed line given a reference number of 130.

The AMR 6a arrives at the work area 13 and stops. The AMR 6a illustrated in a left diagram of FIG. 5 is tilted clockwise with respect to the ideal orientation. As the AMR 6a is tilted, the body 11 is also tilted with respect to the reference orientation 130. An amount of inclination of the AMR 6a and the body 11 is an angle θ.

After stopping in the work area 13, the AMR 6a corrects the inclination of the body 11 using the rotary table 68. The AMR 6a obtains information on the angle θ from the system controller 16.

The system controller 16 determines the angle θ based on an image captured by the external camera 191, the image showing the body 11 located in the work area 13. Determination of the angle θ based on the image can be performed using known image processing techniques. The system controller 16 transmits a correction command for the body 11 and information on the angle θ to the AMR 6a. The angle θ may be positive when the body 11 is tilted clockwise with respect to the reference orientation 130, and may be negative when the body 11 is tilted counterclockwise with respect to the reference orientation 130.

The AMR 6a receives the correction command for the body 11 and the information on the angle θ. As illustrated in a right diagram of FIG. 5, the AMR 6a rotates the body 11 using the rotary table 68 so that the angle θ becomes zero. The orientation of the body 11 is aligned with the reference orientation 130.

FIG. 6 is a flowchart illustrating a control procedure of the AMR 6. In the flow of FIG. 6, an order of steps can be changed, a part of the steps can be omitted, and other steps can be added in the allowed scope.

In step S11 after starting, the AMR 6a determines whether a travel command is received from the system controller 16. The AMR 6a remains stopped until a travel command is received. The travel command includes a destination. Upon receiving the travel command, the AMR 6a travels toward the destination in step S12. The destination includes the work area 13.

In step S13, the AMR 6a determines whether the AMR 6a arrived at the work area 13 designated by the system controller 16 based on the scan data of the scanner 65 and the map data 661. The AMR 6a continues traveling in step S12 until the AMR 6a arrives at the work area 13. When the AMR 6a arrives at the designated work area 13, the AMR 6a stops in step S14.

In step S15, the AMR 6a receives the information on the angle θ from the system controller 16. In the following step S16, the AMR 6a determines whether the angle θ is zero.

When the angle θ is not zero, the AMR 6a corrects the inclination of the body 11 using the rotary table 68 in step S17. After correcting inclination, the AMR 6a receives the information on the corrected angle θ again from the system controller 16 in step S15, and determines whether the angle θ is zero in step S16. The AMR 6a repeats steps S15 to S17 until the angle θ becomes zero.

When the angle θ becomes zero, the AMR 6a transmits a signal indicating that stopping is completed to the system controller 16 in step S18. The process of FIG. 6 returns to step S11.

When the system controller 16 receives a stop completion signal from the AMR 6a, the system controller 16 gives a command to the locator 4 to support the body 11. As illustrated in the right diagram of FIG. 5, the locator 4 adjusts the position of the rod 41 in the front-rear direction and the left-right direction, and then engages the tip of the rod 41 with the body 11 to support the body 11. That is, the locator 4 lifts the body 11 from the carriage 14 as illustrated by the dashed line in FIG. 2. When the support of the body 11 is completed, the system controller 16 gives a command to the robot 2 to perform welding on the body 11. The robot 2 performs welding on the body 11 according to the command.

When supporting the body 11, the locator 4 may adjust the position of the body 11 in the left-right direction and the front-rear direction.

While the robot 2 performs welding, the AMR 6a waits for a travel command from the system controller 16 in step S11.

When the angle θ is zero when the AMR 6a stops in the work area 13 in step S14, the AMR 6a does not correct inclination in step S17, and transmits the stop completion signal to the system controller 16 in step S18.

### Operation and Effect

The AMR 6 does not require a traveling guide. As illustrated in FIG. 1 or FIG. 2, the manufacturing line 10 equipped with the AMR 6 has an advantage that pits required in manufacturing lines of the related art for laying body conveying rails and a body elevator are not required. Since the floor surface in the factory is flat, the manufacturing line 10 equipped with the AMR 6 has an advantage that a change in layout can be easily coped with.

Using the AMR 6 in the manufacturing line 10 makes it possible to adjust production by adjusting the number of AMRs 6. Flexible operation of the manufacturing line 10 is realized.

After the AMR 6a arrives at the work area 13, the robot system 1 can correct the orientation of the body 11 using the rotary table 68 of the AMR 6a. The robot system 1 can use the AMR 6a to match the orientation of the body 11 with the reference orientation 130 with high accuracy.

The AMR 6 does not need to accurately adjust the orientation of the AMR 6a while traveling to the work area 13 or immediately before stopping in the work area 13 to align the orientation of the body 11 with the reference orientation 130. The AMR 6a can quickly move to the work area 13. Since the rotary table 68 rotates the body 11 about the vertical axis, the orientation of the body 11 can be corrected quickly and accurately. After arriving at the work area 13, the AMR 6a can quickly deliver the body 11 to the locator 4. The robot system 1 shortens a time required to transport the body 11, thereby improving production efficiency of the manufacturing line 10.

Correction of the orientation of the body 11 by the locator 4 can be omitted. The reason is that the AMR 6 corrects the orientation of the body 11. The locator 4 may be a small robot such as a three-axis orthogonal robot. The locator 4 having a small size can reduce interference with the robot 2 in the work area 13 that is a spatially limited area. The robot system 1 has an advantage that a range of motion of the robot 2 is not limited by the locator 4.

In addition, the robot system 1 can obtain accurate information on the inclination of the body 11 in the work area 13 using the sensor 19 provided outside of the AMR 6. The robot system 1 can correct the inclination of the body 11 with high accuracy using a simple system.

### First Modification Example of AMR

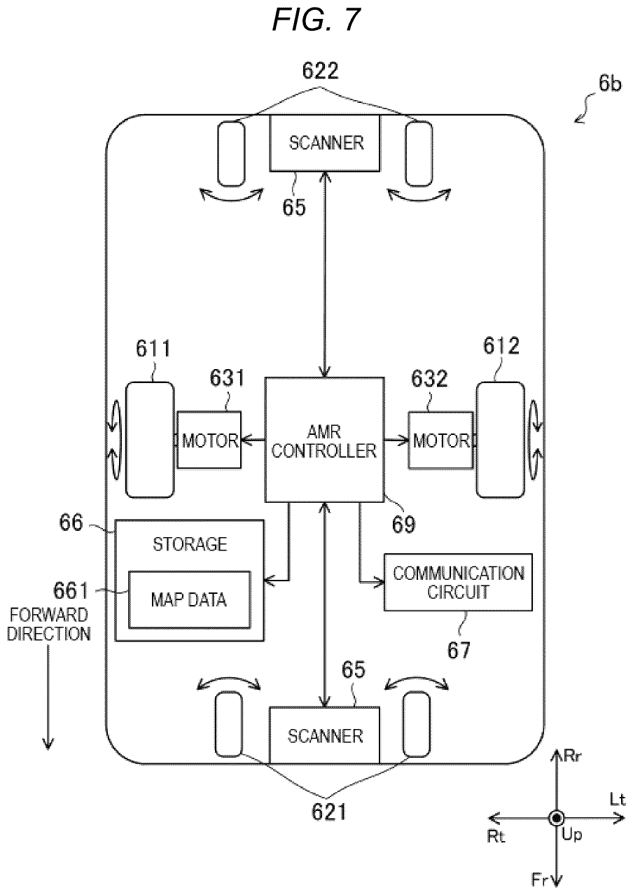

FIG. 7 illustrates an AMR 6b according to a modification example. The AMR 6b in FIG. 7 is an example of the AMR 6. The AMR 6b differs from the AMR 6a in a drive configuration. The AMR 6b does not include a steering mechanism 64. The AMR 6b includes two independent drive wheels 611 and 612. The AMR 6b is an independently driven transport vehicle.

The drive wheel 611 is located on a right side of an intermediate portion of the AMR 6b in the front-rear direction. The drive wheel 612 is located on a left side of the intermediate portion of the AMR 6b. Rotation shafts of the drive wheels 611 and 612 extend in the left-right direction and are coaxial.

The AMR 6b includes passive wheels 621 and passive wheels 622. The passive wheel 621 is located in an intermediate portion in the left-right direction at a front end of the AMR 6b. The passive wheel 622 is located in an intermediate portion in the left-right direction at a rear end of the AMR 6b. Each of the passive wheels 621 and 622 is capable of changing orientation. The AMR 6b may include one passive wheel.

The AMR 6b includes a motor 631 and a motor 632 as drive sources for traveling. The motor 631 is mechanically connected to the drive wheel 611. The motor 632 is mechanically connected to the drive wheel 612. The drive wheels 611 and 612 can rotate independently of each other. When the drive wheels 611 and 612 rotate in the same direction at the same rotation speed, the AMR 6b moves straight. When the drive wheels 611 and 612 rotate in the same direction at different rotation speeds, the AMR 6b turns.

When the drive wheels 611 and 612 rotate in different directions, the AMR 6b turns instantly, that is, rotates about a vertical axis. When the drive wheel 611 rotates in the forward direction and the drive wheel 612 rotates in the backward direction, the AMR 6b rotates in the counterclockwise direction in FIG. 7. When the drive wheel 611 rotates in the backward direction and the drive wheel 612 rotates in the forward direction, the AMR 6b rotates in the clockwise direction in FIG. 7. The AMR 6b that does not include the rotary table 68 can correct the inclination of the body 11 by turning instantly.

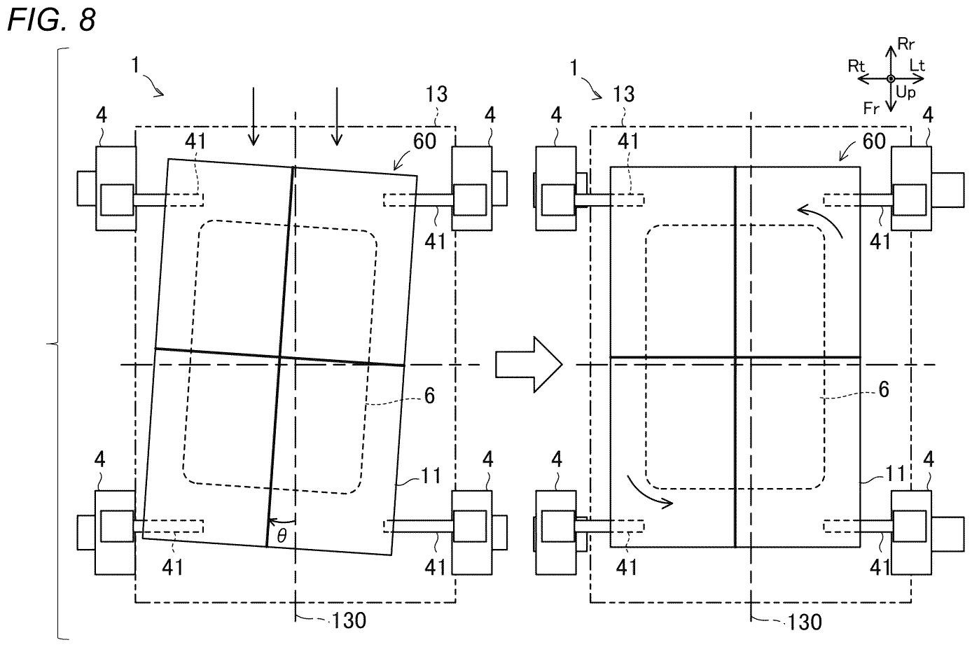

FIG. 8 illustrates a procedure for correcting the inclination of the body 11 by the AMR 6 that can turn instantly. As described above, after the AMR 6 stops in the work area 13, the AMR 6 receives the correction command for the body 11 and the information on the angle θ from the system controller 16. As illustrated in a right diagram of FIG. 8, the AMR 6 turns instantly so that the angle θ becomes zero. As the AMR 6 rotates, the body 11 rotates. When the orientation of the body 11 is aligned with the reference orientation 130, the locator 4 supports the body 11. The robot 2 performs welding on the body 11.

A control procedure for the AMR 6b that can turn instantly follows the flow illustrated in FIG. 6. In step S17, the AMR 6b corrects the inclination of the body 11 by turning instantly instead of using the rotary table 68 to correct the inclination of the body 11.

### Second Modification Example of AMR

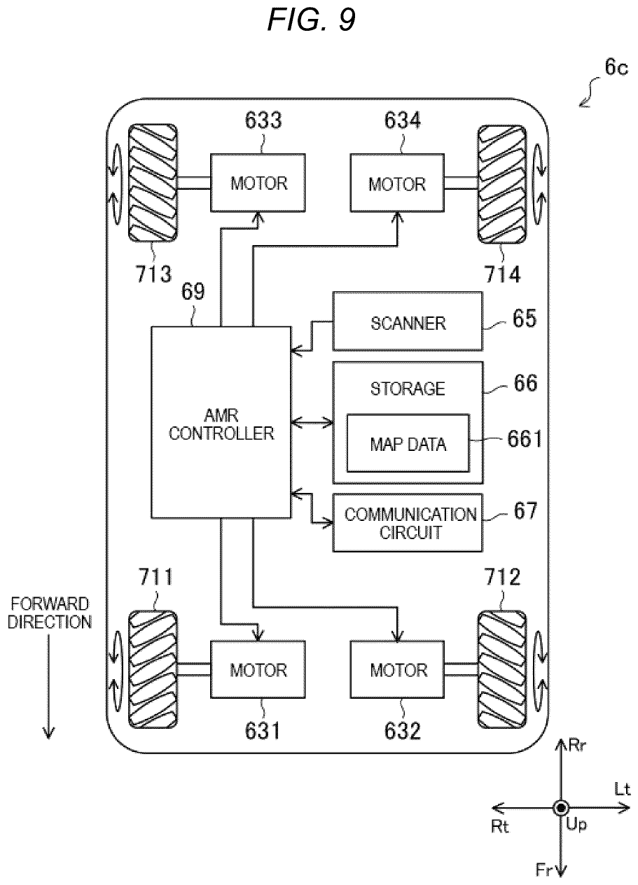

FIG. 9 illustrates an AMR 6c according to a modification example. The AMR 6c in FIG. 9 is an example of the AMR 6. The AMR 6c can turn instantly similarly to the AMR 6b. A drive configuration of the AMR 6c is different from that of the AMR 6b.

The AMR 6c includes Mecanum wheels 711, 712, 713, and 714 that are drive wheels. The Mecanum wheels 711, 712, 713, and 714 are located at four corners of the AMR 6c. Rotation axes of the Mecanum wheels 711, 712, 713, and 714 extend in the left-right direction. An arrangement of the Mecanum wheels 711, 712, 713, and 714 is merely an example. The AMR 6c may include three Mecanum wheels. The three Mecanum wheels are arranged so that the rotation axes intersect each other at one point.

The AMR 6c includes motors 631, 632, 633, and 634. The motor 631 is connected to the Mecanum wheel 711 and the motor 632 is connected to the Mecanum wheel 712. The Motor 633 is connected to the Mecanum wheel 713 and the motor 634 is connected to the Mecanum wheel 714. The four Mecanum wheels 711, 712, 713, and 714 can rotate independently.

By rotating the two Mecanum wheels 711, 713 located on a right side of the AMR 6c in the forward direction and rotating the two Mecanum wheels 712, 714 located on a left side of the AMR 6c in the rearward direction, the AMR 6c can turn instantly in the counterclockwise direction in FIG. 9. By rotating the two Mecanum wheels 712, 714 located on the left side of the AMR 6c in the forward direction and rotating the two Mecanum wheels 711, 713 located on the right side of the AMR 6c in the rearward direction, the AMR 6c can turn instantly in the clockwise direction in FIG. 9.

A procedure for correcting the inclination of the body 11 by the AMR 6c is illustrated in FIG. 8. The AMR 6c is controlled similarly to the AMR 6b according to the flowchart of FIG. 6.

### Third Modification Example of AMR

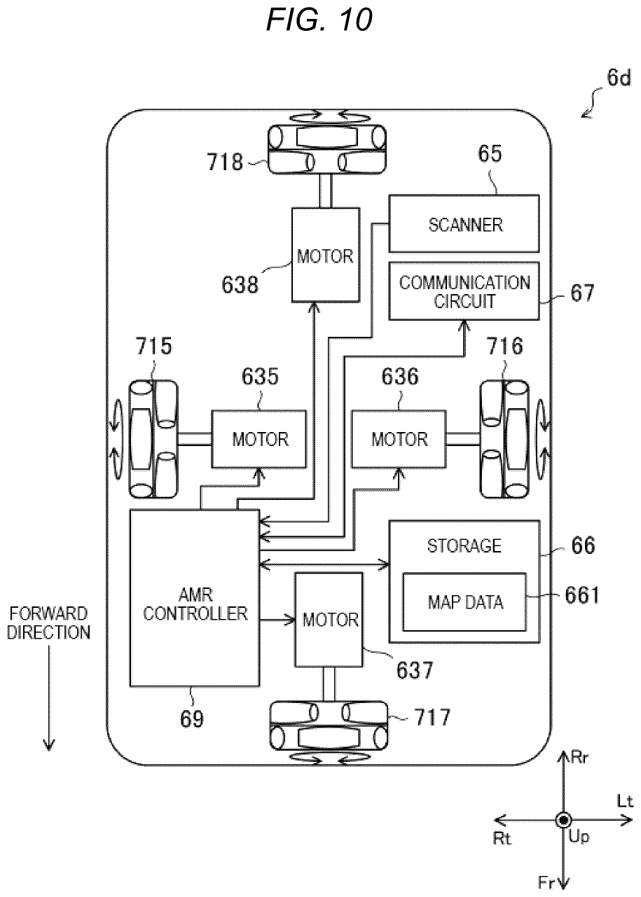

FIG. 10 illustrates an AMR 6d according to a modification example. The AMR 6d in FIG. 10 is an example of the AMR 6. The AMR 6d can turn instantly similarly to the AMR 6b or the AMR 6c. A drive configuration of the AMR 6d is different from the AMR 6b and the AMR 6c.

The AMR 6d includes omni-wheels 715, 716, 717, and 718 that are drive wheels. The omni-wheel 715 and the omni-wheel 716 are located on left and right sides, respectively, of an intermediate portion of the AMR 6d in the front-rear direction. Rotation shafts of the two omni-wheels 715 and 716 extend in the left-right direction and are coaxial. The omni-wheel 717 and the omni-wheel 718 are located on front and rear sides, respectively, of an intermediate portion of the AMR 6d in the left-right direction. Rotation shafts of the two omni-wheels 717 and 718 extend in the front-rear direction and are coaxial. An arrangement of the omni-wheels 715, 716, 717, and 718 is merely an example. The AMR 6d may include three omni-wheels. The three omni-wheels are arranged so that the rotation axes intersect each other at one point.

The AMR 6d includes motors 635, 636, 637, and 638. The motor 635 is connected to the omni-wheel 715 and the motor 636 is connected to the omni-wheel 716. The motor 637 is connected to the omni-wheel 717 and the motor 638 is connected to the omni-wheel 718. The four omni-wheels 715, 716, 717, and 718 can rotate independently.

When the omni-wheels 715 and 716 are stopped and the omni-wheels 717 and 718 are rotated in the forward or backward direction, the AMR 6d can turn instantly in the clockwise or counterclockwise direction.

A procedure for correcting the inclination of the body 11 by the AMR 6d is illustrated in FIG. 8. The AMR 6d is controlled similarly to the AMR 6b or AMR 6c according to the flowchart of FIG. 6.

### Control of AMR Using Stopper

The robot system 1 may use a stopper to stop the AMR 6. The AMR 6 can autonomously stop in the work area 13. By using the stopper, an accuracy of a stopping position of the AMR 6 in the front-rear direction can be further improved.

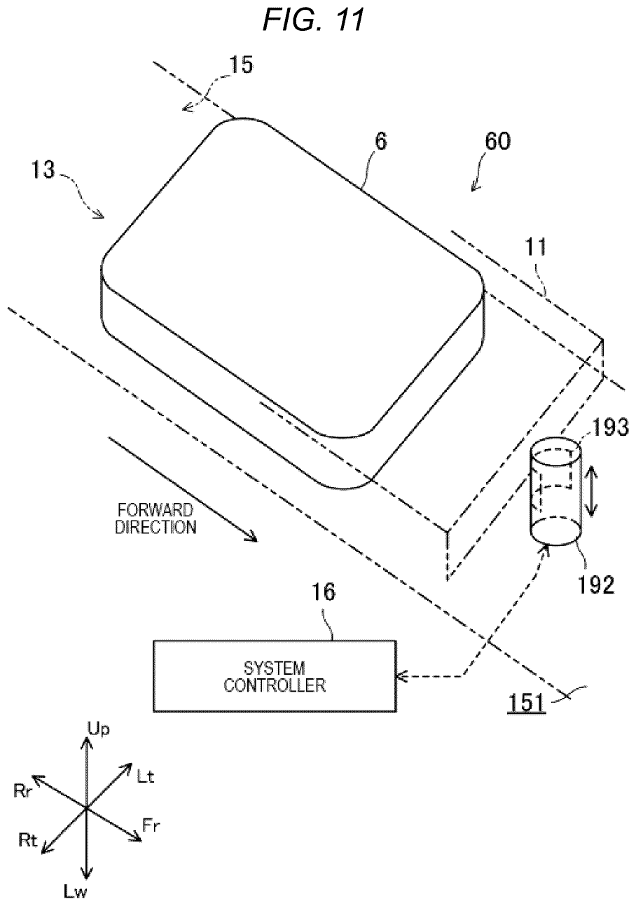

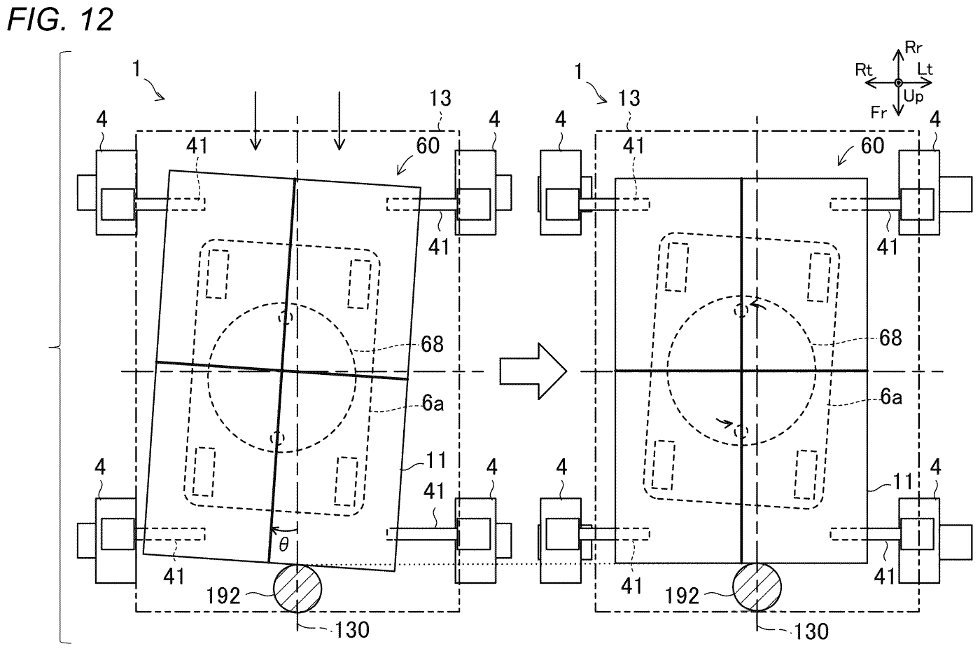

FIG. 11 illustrates a stopper 192 placed in the work area 13. The stopper 192 protrudes upward from a floor surface 151 of the path 15. In the illustrated example, the stopper 192 is a pole. As illustrated in FIG. 12, the stopper 192 is located in front of the moving body 60 in the forward direction of the moving body 60. The stopper 192 is located at a center of the path 15 in the left-right direction. In other words, the stopper 192 is located at a center of the path 15 in a width direction.

The moving body 60 that moves along the path 15 bumps against the stopper 192. In the example of FIG. 11, the stopper 192 is bumped against the body 11. The stopper 192 may bump against the AMR 6 or the carriage 14.

The stopper 192 includes a lifting mechanism. As illustrated by the arrow in FIG. 11, the stopper 192 switches between a first position where the stopper 192 protrudes upward from the floor surface 151 of the path 15 and a second position where the stopper 192 does not protrude from the floor surface 151 of the path 15. The stopper 192 located in the first position interferes with a front portion of the moving body 60 in a traveling direction. The stopper 192 located in the first position restricts the moving body 60 from moving forward. The stopper 192 in the second position does not interfere with the moving body 60. The moving body 60 can pass over the stopper 192. The stopper 192 is electrically connected to the system controller 16. The system controller 16 outputs a signal to the stopper 192 to give a command to switch the position of the stopper 192. The stopper 192 switches between the first position and the second position based on the signal from the system controller 16.

The stopper 192 includes a sensor 193. The sensor 193 outputs a signal related to contact or adjacency of the moving body 60 and the stopper 192 to the system controller 16. Various types of sensor known in the related art may be used as the sensor 193. The system controller 16 receives the signal from the sensor 193 and notifies the AMR 6 of interference between the moving body 60 and the stopper 192. The AMR 6 stops based on the signal from the system controller 16.

FIG. 12 illustrates a procedure for correcting the inclination of the body 11 by the AMR 6 when the stopper 192 is used. The AMR 6 is the AMR 6a including the rotary table 68 illustrated in FIG. 4. As illustrated in a left diagram of FIG. 12, the AMR 6a receives interference information from the system controller 16 based on the signal from the sensor 193 and stops in the work area 13. The AMR 6a stops when the moving body 60 interferes with the stopper 192. In the illustrated example, the AMR 6a is stopped while the body 11 is bumped against the stopper 192. The AMR 6 may decelerate before bumping against the stopper 192. The deceleration is performed to reduce an impact when the moving body 60 bumps against the stopper 192.

After the AMR 6a stops, the AMR 6a receives the correction command for the body 11 and the information on the angle θ from the system controller 16. As illustrated in a right diagram of FIG. 12, the rotary table 68 rotates so that the angle θ of the body 11 becomes zero. While the body 11 is bumped against the stopper 192, the orientation of the body 11 coincides with the reference orientation 130.

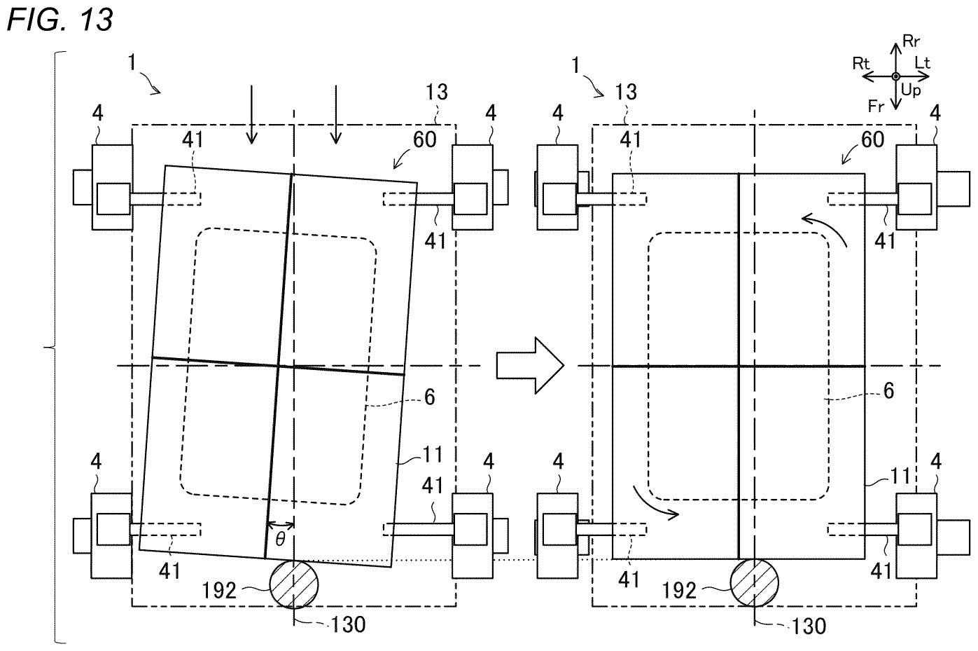

FIG. 13 illustrates a procedure for correcting the inclination of the body 11 by the AMR 6 when the stopper 192 is used. The AMR 6 is the AMR 6b, 6c or 6d illustrated in FIG. 7, 9 or 10 that can turn instantly. As illustrated in a left diagram of FIG. 13, after the AMR 6 stops while the moving body 60 interferes with the stopper 192, the AMR 6 obtains the information on the angle θ from the system controller 16.

As illustrated in a right diagram of FIG. 13, the AMR 6 turns instantly based on the information on the angle θ so that the angle θ of the body 11 becomes zero. While the body 11 is bumped against the stopper 192, the orientation of the body 11 coincides with the reference orientation 130.

By using the stopper 192, it is possible to accurately position the body 11 at a reference position in the front-rear direction in the work area 13. The reference position in the front-rear direction is the position of the body 11 in the front-rear direction when the robot 2 performs welding on the body 11.

Since the AMR 6 corrects the inclination of the body 11, the orientation of the body 11 is also accurately aligned with the reference orientation.

The stopper 192 is not limited to a pole. A structure of the stopper is not limited as long as the stopper is capable of restricting a forward movement of the moving body 60 by interfering with the moving body 60.

### Other Modification Examples

After the AMR 6 corrects the inclination of the body 11 in step S17 of the flow in FIG. 6, the process may proceed to step S18 without returning to step S15. In other words, when the AMR 6 corrects the inclination of the body 11 so that the angle θ becomes zero based on the information on the angle θ received in step S15, confirmation of the angle θ may be omitted.

When the angle θ of the body 11 is zero, the system controller 16 does not need to transmit information on the angle θ to the AMR 6. When the system controller 16 switches whether to transmit information on the angle θ, the AMR 6 may determine whether the AMR 6 received the information on the angle θ from the system controller 16 in steps S15 and S16 of the flow in FIG. 6. When angle information is received, the AMR 6 corrects the inclination of the body 11 in step S17, and when the angle information is not received, in other words, when the AMR 6 receives information indicating correction is not required, the AMR 6 may transmit the stop completion signal to the system controller 16 in step S18.

In step S16 of the flow in FIG. 6, the AMR 6 may determine whether the angle θ is substantially zero. That is, the AMR 6 may determine in step S16 whether the angle θ is within the range of 0±α°.

α can be set to an appropriate angle. For example, α may be set within a range in which the rods 41 of the plurality of locators 4 can support the body 11 that arrived at the work area 13. The locator 4 can move a tip position of the rod 41 in the front-rear direction and the left-right direction within a specific range. a may be determined considering an adjustment margin for the position of the rod 41.

The AMR 6b, 6c or 6d that can turn instantly illustrated in FIG. 7, 9 or 10 may include the rotary table 68 of the AMR 6a of FIG. 4. By combining the AMR 6b, 6c or 6d that can turn instantly with the rotary table 68, it is possible to change the orientation of the AMR 6b, 6c or 6d without changing the orientation of the body 11.

The robot system 1 may include an AGV as a transport vehicle. Like the AMR, the AGV may be tilted from a predetermined orientation when stopped in the work area 13. The above-described control for correcting the inclination of the body 11 can be applied to the AGV.

In the robot system 1, the system controller 16 may be omitted. The robot system 1 may achieve the above-described control by mutual communication between the robot controller 17, the locator controller 18, and the AMR 6.

The number of external cameras 191 is not limited to one, and may be two or more. A plurality of cameras can be placed in suitable locations. The system controller 16 may determine the angle θ of the body 11 based on a composite image obtained by combining images captured by a plurality of cameras.

The external camera 191 may be attached to the robot 2 instead of being fixed to a factory building as illustrated in FIG. 2.

Instead of or in addition to the external camera 191, the AMR 6 may include one or a plurality of cameras. The system controller 16 or the AMR 6 may determine the angle θ of the body 11 using images captured by the cameras of the AMR 6.

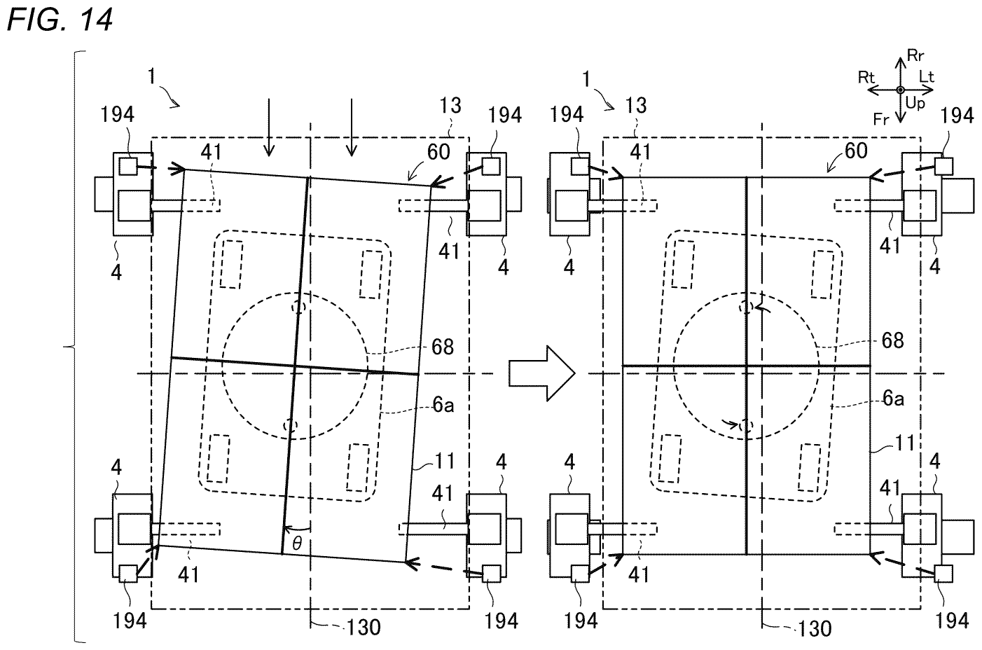

The system controller 16 may determine the angle θ of the body 11 based on measurement signals from one or a plurality of distance measuring sensors instead of images captured by cameras. FIG. 14 illustrates the robot system 1 using a distance measuring sensor 194 as the sensor 19 provided outside. Various types of sensor known in the related art may be used as the distance measuring sensor 194.

In FIG. 14, the distance measuring sensor 194 is attached to the locator 4. Each distance measuring sensor 194 measures a distance to the moving body 60 stopped in the work area 13. The system controller 16 can determine the inclination of the body 11 based on measurement signals of the plurality of distance measuring sensors 194. The distance measuring sensors 194 may be placed at any suitable locations.

When the stopper 192 interferes with the AMR 6 instead of the body 11, the sensor 193 can be omitted. The AMR 6 may include a sensor that detects interference with the stopper 192 instead of the sensor 193.

The robot system 1 may include an articulated robot that supports the body 11 instead of or in addition to the locator 4.

The configurations in each of the above-described examples of the AMR 6 can be mutually applied to each of the examples of the AMR 6 individually or in combination with other configurations in a reasonable scope.

The work to be performed on the manufacturing line 10 by the robot system 1 disclosed herein is not limited to welding. The workpiece that the robot system 1 works on is not limited to the body 11 of the automobile. The robot system 1 is not limited to a system applied to the manufacturing line 10 for automobile.

Functions of elements disclosed herein may be implemented using a circuit or a processing circuit including general purpose processors, dedicated processors, integrated circuits, application specific integrated circuits (ASIC), circuits of the related art, and/or combinations thereof, configured or programmed to perform the disclosed functions. A processor is considered to be a processing circuit or a circuit as the processor contains transistors and other circuits. In the disclosure, a circuit, a unit, and a means are hardware that executes the listed functions or hardware that is programmed to execute the listed functions. The hardware may be hardware disclosed herein or other known hardware configured to implement or programmed to execute the listed functions. When the hardware is a processor considered as a type of circuit, the circuit, the means and the unit are a combination of hardware and software, and the software is used for the hardware and/or the processor.

### ASPECTS

The above-described embodiments are specific examples of the following aspects.
First Aspect

A robot system (1) including:
a robot (2) that is configured to perform work on a workpiece (11) transported to a work area (13);
a sensor (19) that is configured to output a signal related to inclination of the workpiece (11) with respect to a reference orientation (130) when the robot (2) performs work on the workpiece (11), the signal being related to the inclination of the workpiece (11) that arrived at the work area (13); and
a transport vehicle (6) that is configured to transport the workpiece (11) to the work area (13) and configured to correct the inclination of the workpiece (11) based on the signal from the sensor (19) so that the workpiece (11) is aligned with the reference orientation (130) in the work area (13).

The robot system (1) can use the transport vehicle (6) to accurately align the orientation of the workpiece (11) with the reference orientation (130) in the work area (13). That is, as the transport vehicle that transports the workpiece to the work area corrects inclination of the workpiece, the robot system can accurately align the orientation of the workpiece with the reference orientation.

The robot system (1) can also use the sensor (19) provided outside to obtain accurate information on the inclination of the workpiece (11) in the work area (13). The robot system (1) can implement highly accurate correction of the inclination of the workpiece (11) using a simple system.
(Second Aspect)

The robot system (1) according to the first aspect, in which
the transport vehicle (6a) includes a rotary table (68) that is configured to rotate the workpiece (11) about a vertical axis, and
the rotary table (68) is configured to correct the inclination of the workpiece (11) by rotating the workpiece (11) after the transport vehicle (6a) stops in the work area (13).

The rotary table (68) rotates the workpiece (11) about the vertical axis so that the orientation of the workpiece (11) can be quickly and accurately corrected. The robot system (1) can shorten a time required to transport the workpiece (11) including positioning of the workpiece (11), in a manufacturing line.
(Third Aspect)

The robot system (1) according to the first aspect or second aspect, in which
the transport vehicle (6b, 6c, 6d) is configured to turn about a vertical axis, and
the transport vehicle (6b, 6c, 6d) is configured to correct the inclination of the workpiece (11) by turning after stopping in the work area (13).

The transport vehicles (6b, 6c, 6d) rotate the workpiece (11) about the vertical axis by turning instantly so that the orientation of the workpiece (11) can be quickly and accurately corrected. The robot system (1) can shorten a time required to transport the workpiece (11) including positioning of the workpiece (11).
(Fourth Aspect)

The robot system (1) according to any one of the first aspect to third aspect, further including:
a stopper (192) that is configured to interfere with a front portion of a moving body (60) including the workpiece (11) and the transport vehicle (6) in a traveling direction in the work area (13), in which
the transport vehicle (6) is configured to stop while the moving body (60) is bumped against the stopper (192) and configured to correct the inclination of the workpiece (11) after the transport vehicle (6) stops.

By using the stopper (192), it is possible to accurately position the workpiece (11) at a reference position in the work area (13) with respect to the traveling direction of the moving body. Since the moving body (60) corrects the inclination of the workpiece (11), the orientation of the workpiece (11) can also be accurately determined to be in a reference orientation.
(Fifth Aspect)

The robot system (1) according to any one of the first aspect to fourth aspect, in which the transport vehicle is an autonomous mobile robot (6a, 6b, 6c, 6d).

The autonomous mobile robot (6a, 6b, 6c, 6d) can transport the workpiece (11) to the work area (13) by traveling on a flat floor surface. No pits are required for transporting the workpiece (11). By using the autonomous mobile robot (6a, 6b, 6c, 6d), an advantage of being able to easily cope with a change in layout of the manufacturing line can be achieved.

The autonomous mobile robot (6a, 6b, 6c, 6d) does not need to accurately adjust the orientation of the workpiece (11) during transportation of the workpiece (11) to the work area (13). This is because the autonomous mobile robot (6a, 6b, 6c, 6d) corrects the orientation of the workpiece (11) in the work area (13). The autonomous mobile robot (6a, 6b, 6c, 6d) can quickly move to the work area (13). The robot system (1) can shorten a time required to transport the workpiece (11) including positioning of the workpiece (11).
(Sixth Aspect)

The robot system (1) according to any one of the first aspect to fifth aspect, further including:
a locator (4) that is located in the work area (13) and that is configured to support the workpiece (11) delivered from the transport vehicle (6) while the robot (2) is working.

Since the transport vehicle (6) corrects the orientation of the workpiece (11), correction of the orientation of the workpiece (11) by the locator (4) can be omitted. The robot system can employ the locator (4) having a small size. When the locator (4) has a small size, interference between the locator (4) and the robot (2) in the work area (13) is reduced. The locator (4) having a small size is advantageous in expanding a movable area of the robot (2).
(Seventh Aspect)

The robot system (1) according to any one of the first aspect to sixth aspect, in which the sensor (19) is a camera (191) that is configured to photograph the workpiece (11) located in the work area (13).

By using the camera (191), the inclination of the workpiece (11) can be detected easily and accurately.

What is claimed is:

1. A robot system comprising:
a robot that is configured to perform work on a workpiece transported to a work area;
a sensor that is configured to output a signal related to inclination of the workpiece with respect to a reference orientation when the robot performs work on the workpiece, the signal being related to the inclination of the workpiece that arrived at the work area; and
a transport vehicle that is configured to transport the workpiece to the work area and configured to correct the inclination of the workpiece based on the signal from the sensor so that the workpiece is aligned with the reference orientation in the work area.

2. The robot system according to claim 1, wherein
the transport vehicle includes a rotary table that is configured to rotate the workpiece about a vertical axis, and
the rotary table is configured to correct the inclination of the workpiece by rotating the workpiece after the transport vehicle stops in the work area.

3. The robot system according to claim 1, wherein
the transport vehicle is configured to turn about a vertical axis, and
the transport vehicle is configured to correct the inclination of the workpiece by turning after stopping in the work area.

4. The robot system according to claim 1, further comprising:
a stopper that is configured to interfere with a front portion of a moving body including the workpiece and the transport vehicle in a traveling direction in the work area, wherein
the transport vehicle is configured to stop while the moving body is bumped against the stopper, and configured to correct the inclination of the workpiece after the transport vehicle stops.

5. The robot system according to claim 1, wherein the transport vehicle is an autonomous mobile robot.

6. The robot system according to claim 1, further comprising:
a locator that is located in the work area and that is configured to support the workpiece delivered from the transport vehicle while the robot is working.

7. The robot system according to claim 1, wherein the sensor is a camera that is configured to photograph the workpiece located in the work area.
